(19) United States
(12) Patent Application Publication
(10) Pub. No.: US 2026/0103356 A1
(43) Pub. Date: Apr. 16, 2026

(54) SEALING MATERIAL SUPPLY DEVICE

(71) Applicant: TOYOTA JIDOSHA KABUSHIKI KAISHA, Toyota-shi (JP)

(72) Inventor: Koichi YANASE, Nagoya-shi (JP)

(73) Assignee: TOYOTA JIDOSHA KABUSHIKI KAISHA, Toyota-shi (JP)

(21) Appl. No.: 19/208,981

(22) Filed: May 15, 2025

(30) Foreign Application Priority Data
Oct. 11, 2024 (JP) 2024-179296

(51) Int. Cl. B65H 19/18; B65H 19/20; B65H 21/00; H01M 4/04

(52) U.S. Cl. CPC B65H 19/1836; B65H 19/20; B65H 21/00; B65H 2301/46176; B65H 2301/46178; B65H 2301/4621; B65H 2301/4634; B65H 2408/22; H01M 4/0404

(57) ABSTRACT

There is provided a sealing material supply device that continuously supplies a sealing material to an uncoated portion on an edge portion of a current collector on which an electrode is coated, the sealing material supply device including a pair of main body portions disposed so as to sandwich an old sealing material and a new sealing material, a welding portion provided in each of the main body portions, the welding portion being configured to weld the old sealing material and the new sealing material to each other, and a half-cut portion provided in each of the main body portions, the half-cut portion being configured to cut off a surplus portion of the old sealing material and the new sealing material.

### CROSS-REFERENCE TO RELATED APPLICATION

This application claims priority to Japanese Patent Application No. 2024-179296 filed on Oct. 11, 2024. The disclosure of the above-identified application, including the specification, drawings, and claims, is incorporated by reference herein in its entirety.

### BACKGROUND

### 1. Technical Field

The present disclosure relates to a sealing material supply device.

### 2. Description of Related Art

WO 2011/077499 discloses that when an insulating tape for an electrochemical element is supplied by an automatic supply device, new and old rolls are connected and supplied.

### SUMMARY

The automatic supply device disclosed in WO 2011/077499 is large-scale and is configured of five processes of cutting off an end of an insulating tape, fixing the end, switching to a new roll, pulling out a new roll, and connecting new and old rolls. Therefore, supply takes time. In addition, accordingly, space and cost are needed, and an accumulator for continuous supply also needs to be installed for a longer length.

Considering the above, an object of the present disclosure is to provide a sealing material supply device capable of reducing a process time when new and old sealing materials are connected to each other and supplied.

A sealing material supply device according to the present disclosure is a sealing material supply device that continuously supplies a sealing material to an uncoated portion on an edge portion of a current collector on which an electrode is coated, the sealing material supply device including
a pair of main body portions disposed so as to sandwich an old sealing material and a new sealing material,
a welding portion provided in each of the main body portions, the welding portion being configured to weld the old sealing material and the new sealing material to each other, and a half-cut portion provided in each of the main body portions, the half-cut portion being configured to cut off a surplus portion of the old sealing material and the new sealing material,
in which the old sealing material and the new sealing material are welded to each other by the welding portion while the old sealing material and the new sealing material are transported, and at the same time, the surplus portion of the old sealing material and the new sealing material is cut off by the half-cut portion.

According to the present disclosure, it is possible to reduce the process time when the new and old sealing materials are connected to each other and supplied.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a diagram showing a schematic configuration of a sealing material supply device according to an embodiment; and

FIG. 2 is a diagram showing an operation of connecting an old sealing material and a new sealing material in the sealing material supply device according to the embodiment.

### DETAILED DESCRIPTION OF EMBODIMENTS

A sealing material supply device according to an embodiment of the present disclosure will be described with reference to the drawings. The components in the following embodiments include elements that can be easily replaced by those skilled in the art or substantially the same components.

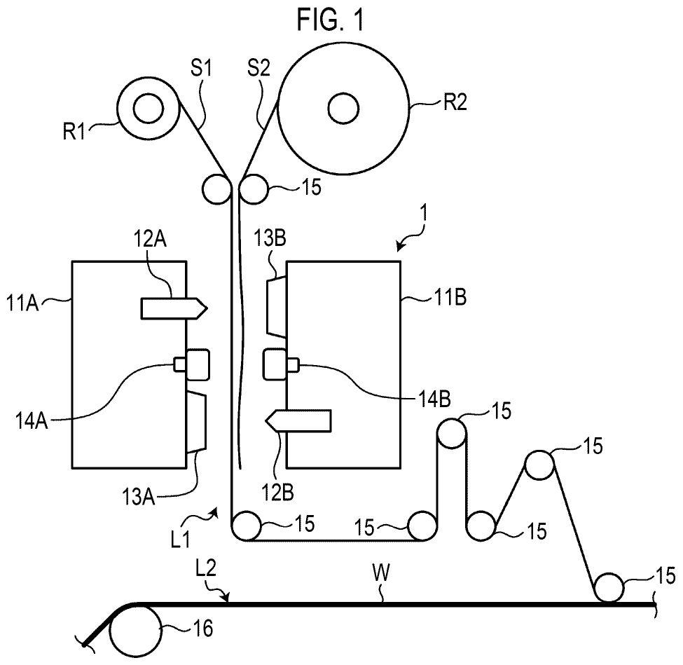

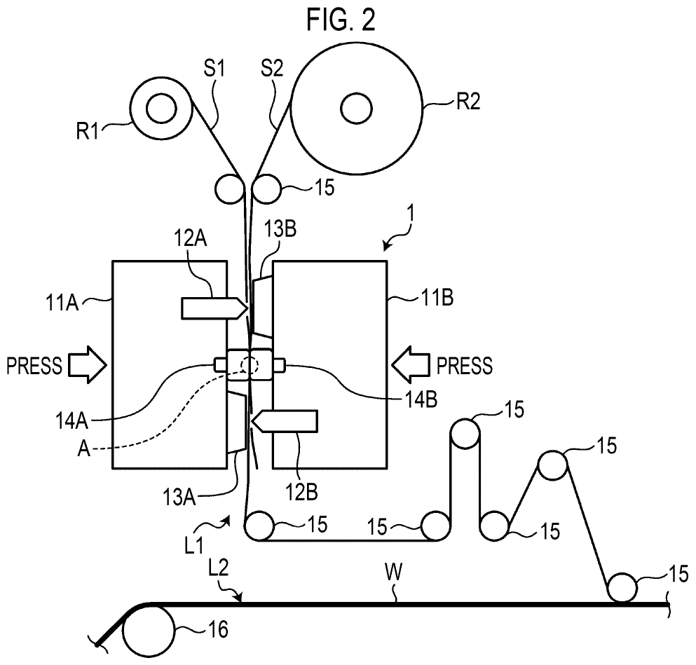

The configuration of a sealing material supply device according to an embodiment will be described with reference to FIGS. 1 and 2. A sealing material supply device according to an embodiment is a device that supplies a sealing material. As shown in FIG. 1, a sealing material supply device 1 continuously supplies the sealing material to an uncoated portion of the edge portion of a current collector (a current collecting foil) W on which an electrode is coated, for example, in a case where a battery cell, such as a lithium ion battery, is manufactured.

The sealing material supply device 1 performs a process of connecting the new and old sealing materials in a case where the remaining amount of the sealing material supplied to the current collector W is small. In the present embodiment, the sealing material before replacement (currently being supplied) is referred to as an old sealing material S1, the roll on which the old sealing material S1 is wound is referred to as an old roll R1, the sealing material after replacement is referred to as a new sealing material S2, and the roll on which the new sealing material S2 is wound is referred to as a new roll R2. In addition, FIG. 1 shows a state in which the tip of the new sealing material S2 is pulled out by a predetermined length in order to connect the new sealing material S2 to the old sealing material S1 in a case where the currently supplied old sealing material S1 is reduced. The length of the new sealing material S2 to be pulled out is set to at least a position lower than a half-cut portion 12B.

As shown in FIG. 1, the sealing material supply device 1 includes a pair of main body portions 11A, 11B, a pair of half-cut portions 12A, 12B, a pair of receivers 13A, 13B, and a pair of welding portions 14A, 14B.

The main body portions 11A, 11B are attached to a press device (not shown) or the like, and are disposed, for example, so as to sandwich the old sealing material S1 and the new sealing material S2. In addition, the main body portions 11A, 11B are configured to be movable in a direction in which the main body portions 11A, 11B approach each other by a press device. The half-cut portion 12A, the receiver 13A, and the welding portion 14A are provided in the main body portion 11A. In addition, the main body portion 11B is provided with the half-cut portion 12B, the receiver 13B, and the welding portion 14B.

The half-cut portion 12A is for cutting off the surplus portion of the old sealing material S1. The half-cut portion 12A is brought close to the receiver 13B relatively to cut off the surplus portion of the old sealing material S1. In addition, the half-cut portion 12A cuts off the end portion on the upstream side of the old sealing material S1. In addition, the tip of the half-cut portion 12A and the center of the receiver 13B are disposed on the same axis.

As shown in FIG. 1, the old sealing material S1 and the new sealing material S2 are present between the half-cut portion 12A and the receiver 13B. However, by managing the stroke amount (the amount of movement) of the half-cut portion 12A with respect to the receiver 13B, solely the old sealing material S1 is cut off by the half-cut portion 12A.

The half-cut portion 12B is for cutting off the surplus portion of the new sealing material S2. The half-cut portion 12B is brought close to the receiver 13A relatively to cut off the surplus portion of the new sealing material S2. In addition, the half-cut portion 12B cuts off the start end of the new sealing material S2 on the downstream side. Further, the tip end of the half-cut portion 12B and the center of the receiver 13A are disposed on the same axis.

As shown in FIG. 1, the new sealing material S2 and the old sealing material S1 are present between the half-cut portion 12B and the receiver 13A. However, by managing the stroke amount (the amount of movement) of the half-cut portion 12B with respect to the receiver 13A, solely the new sealing material S2 is cut off by the half-cut portion 12B.

The receiver 13A functions as a receiving material in a case where the new sealing material S2 is cut off by the half-cut portion 12B. In addition, the receiver 13B functions as a receiving material in a case where the old sealing material S1 is cut off by the half-cut portion 12A.

The welding portions 14A, 14B are made up of a soldering iron or the like. The welding portions 14A, 14B are disposed coaxially with each other. In addition, the welding portions 14A, 14B weld the old sealing material S1 and the new sealing material S2 by, for example, approaching each other as shown in the A portion of FIG. 2 and pressing the old sealing material S1 and the new sealing material S2 from both sides.

Instead of the welding portions 14A, 14B, a heat gun that welds the old sealing material S1 and the new sealing material S2 with hot air, a device that adheres the old sealing material S1 and the new sealing material S2 with an adhesive, a device that adheres the old sealing material S1 and the new sealing material S2 with a tape, or the like may be used.

A plurality of free rollers 15 are disposed in the seal path line L1 through which the old sealing material S1 and the new sealing material S2 are transported. Further, a free roller 16 is disposed on the main transport line L2 on which the current collector W is transported.

In the sealing material supply device 1, as shown in FIG. 2, the old sealing material S1 and the new sealing material S2 are transported, and the old sealing material S1 and the new sealing material S2 are welded by the welding portions 14A, 14B. In addition, at the same time, the surplus portions of the old sealing material S1 and the new sealing material S2 are cut off by the half-cut portions 12A, 12B.

In FIG. 2, an example of a case where the old sealing material S1 and the new sealing material S2 are welded and the surplus portion is cut off by the approach of the main body portions 11A, 11B to each other at the same time is shown. In contrast, for example, any one of the main body portions 11A or 11B may approach any other one of the main body portions 11A or 11B to perform the welding of the old sealing material S1 and the new sealing material S2 and the cutting off of the surplus portion at the same time.

In the sealing material supply device according to the embodiment described above, the new and old sealing materials to be welded to the current collector W and the surplus portion can be welded and cut off in one process. That is, with the sealing material supply device according to the embodiment, the welding of the old sealing material S1 and the new sealing material S2, the cutting off of the surplus portion of the old sealing material S1, and the cutting off of the surplus portion of the new sealing material S2 are performed at the same time. As a result, it is possible to reduce the process time in a case where the new and old sealing materials are connected to each other and supplied. Further, with the sealing material supply device according to the embodiment, the new and old sealing materials can be cut off at the desired position, and thus the new and old sealing materials can be welded while the surplus portion is minimized.

In addition, in the sealing material supply device according to the embodiment, for example, each of the interval between the half-cut portion 12A and the receiver 13A and the interval between the half-cut portion 12B and the receiver 13B is narrowed. As a result, the length of the surplus portion of the old sealing material S1 and the new sealing material S2 can be shortened. As a result, the generation of the surplus portion in a case where the new and old sealing materials are welded can be minimized as much as possible.

In addition, in order to minimize the surplus portion of the new sealing material S2, there is a need to detect the position of the tip end of the new sealing material S2, but the detection method is not particularly limited. For example, the distance from the free roller 15 disposed at the top in FIG. 1 to the half-cut portion 12A and the circumference of the free roller 15 are previously known. Therefore, the position of the tip end of the new sealing material S2 can be detected by detecting the rotation speed of the free roller 15 by a sensor or the like (not shown). In addition, a sensor may be attached to the main body portion 11B to detect the position of the distal end of the new sealing material S2.

Further effects and modification examples can be easily derived by those skilled in the art. Therefore, the broader aspects of the present disclosure are represented as above, and are not limited to the specific details and representative embodiments described above. Therefore, various changes can be made without departing from the spirit or scope of the general inventive concept defined by the appended claims and their equivalents.

For example, in FIGS. 1 and 2, the description is made on the premise of a situation in which the old sealing material S1 is almost used up and the old sealing material S1 and the new sealing material S2 are connected to each other. However, in a case where the old sealing material S1 remains sufficiently, the old sealing material S1 alone can be supplied. In this case, solely the old sealing material S1 is transported through the seal path line L1, and the new roll R2 is set at the position of FIG. 1 in a state before being pulled out.

What is claimed is:

1. A sealing material supply device that continuously supplies a sealing material to an uncoated portion on an edge portion of a current collector on which an electrode is coated, the sealing material supply device comprising:
a pair of main body portions disposed so as to sandwich an old sealing material and a new sealing material;
a welding portion provided in each of the main body portions, the welding portion being configured to weld the old sealing material and the new sealing material to each other; and
a half-cut portion provided in each of the main body portions, the half-cut portion being configured to cut off a surplus portion of the old sealing material and the new sealing material,
wherein the old sealing material and the new sealing material are welded to each other by the welding portion while the old sealing material and the new sealing material are transported, and at the same time, the surplus portion of the old sealing material and the new sealing material is cut off by the half-cut portion.
